(19) United States
(12) Patent Application Publication
(10) Pub. No.: US 2015/0193860 A1
(43) Pub. Date: Jul. 9, 2015

(54) ELECTRONIC COMMERCE SYSTEM AND METHOD

(71) Applicants: Robert A. Walker, Westford, MA (US); Anthony C. Salvo, Westford, MA (US)

(72) Inventors: Robert A. Walker, Westford, MA (US); Anthony C. Salvo, Westford, MA (US)

(21) Appl. No.: 14/591,266

(22) Filed: Jan. 7, 2015

Related U.S. Application Data
(60) Provisional application No. 61/924,460, filed on Jan. 7, 2014.

(51) Int. Cl. G06Q 30/06; G06Q 10/08

(52) U.S. Cl. CPC G06Q 30/0635; G06Q 10/087

(57) ABSTRACT

A method of electronic commerce includes a system at a first location receiving a buyer order communicated to the system, wherein the buyer order specifies a plurality of order characteristics selected from product components, product attributes, a product price, and/or delivery terms. The system identifies one or more inventory products of at least one merchant having the order characteristics of the buyer order. The system assigns a value to the inventory product characteristics and the system calculates an inventory score for each inventory product based on an aggregate of the assigned values. The system determines and filters one or more matching inventory products and communicates to the buyer the matching inventory products together with a respective merchant offer to purchase, where the matching inventory products are arranged according to the inventory score.

### BACKGROUND OF THE INVENTION

1. Field of the Invention

The present invention relates generally to computer-implemented methods and more particularly to an electronic commerce system and method.

2. Description of the Prior Art

Since the beginning of commerce conducted with the help of the Internet, consumers have used various methods to find and place orders for a desired product. The product sought may be tangible or intangible goods or services that are deliverable to the consumer by traditional shipping methods or by electronic delivery. Consumers have used electronic commerce platforms to search for and buy goods and services, such as books, music, household goods, office supplies, autos, travel reservations, and financial instruments.

The process that consumers use to locate and purchase items over the Internet commonly includes searching for a product, sorting through relevant and irrelevant search results, reviewing the relevant search results to narrow the results to products desired by the consumer, and comparing the narrowed search results that are spread across many websites or offered by a large number of merchants. In some cases, this process is acceptable because the consumer is able to locate the exact item sought and offered by a supposedly reliable merchant with acceptable pricing and delivery terms. In other cases, particularly when the consumer has specific purchase requirements, it is difficult to determine the results that best match the consumer's request. The consumer must then spend time to evaluate many choices from a group of similar products that each meets most, but not all of the requirements and may have different pricing, delivery, and product options.

### SUMMARY OF THE INVENTION

Unfortunately, the above-described Internet shopping experience can be complex, time consuming, and frustrating because the buyer is responsible for all due diligence in searching, comparing, evaluating, and purchasing the product. The buyer may need to research multiple web-sites that display similar, but usually not identical products. The buyer also may need to simultaneously interact with multiple browser windows to compare products.

For example, a buyer may want to buy a red sedan within fifty miles of home, for under $20,000, having black cloth interior, and also having certain other options. To find such a car, the buyer would need to find and visit the websites (or in person) of individual manufacturers and car dealers within fifty miles of the buyer's home, browse the available inventory at those websites for red sedans, analyze the options for each red sedan in stock, compare prices, and more. Due to the large number of cars that do not match the red sedan wanted, the buyer wastes time sifting through information. For a complex purchase with many choices, such as for a car, this process can take many hours. Even for a relatively simple purchase, such as buying a ream of white paper, the process can be time consuming and frustrating.

To actually find the product sought, the buyer may need to update and repetitively enter product search data in order to find suitable search results. Also, the buyer is never certain of receiving the best price and/or delivery service. Further, the consumer is subject to terms and conditions of multiple sellers, all which must be considered as part of the purchase. Still further, knowing that the purchaser will likely accept non-conforming goods, some merchants sell one product to the buyer over the Internet, but actually ship another product with similar, but not exact, specifications.

For any financial transaction, the buyer also needs to enter personal payment information at each merchant website. The buyer may interact with a fraudulent or financially distressed website, potentially taking a risk when providing credit card or other payment information. Further, consumers are subjected to unsolicited advertising merely as a result of visiting or searching for products on the Internet. To avoid these frustrations, the consumer often buys a product knowing that better price and/or other terms are probably available, but not wanting to spend more valuable time to find the best deal.

Accordingly, a need exists for an e-commerce system and method that improves the ability to connect buyers and sellers for a specified product. Embodiments of the present invention leverage modern Internet and mobile technology to improve interactions between buyers and sellers.

It is an object of the present invention to reduce the time and effort required of buyers to purchase a product or service.

It is another object of the present invention to present purchasing options that more closely match the desires of the buyer.

It is another object of the present invention to present to the buyer with offers to buy a product or service with competitive pricing and/or other terms.

It is another object of the present invention to connect qualified buyers to qualified sellers.

It is another object of the present invention to increase the closing-to-bid ratio of today's e-commerce platforms.

The present invention achieves these and other objectives by providing a system and method of e-commerce. In one embodiment, a method of electronic commerce includes a system at a first location receiving a buyer order defining one or more actual products communicated to the system from a buyer computer located at a different location. The buyer order specifies a plurality of order characteristics selected from one or more product components, one or more product attributes, a product price, and one or more delivery term. The system determines whether each inventory product characteristics is equal to, within an acceptable range of, or unequal to the respective one of the plurality of order characteristics of the buyer order, thereby identifying one or more inventory products of at least one merchant having the plurality of order characteristics. The system assigns a value to each of the plurality of inventory product characteristics, where being equal to the respective order characteristic of the buyer order has a first value, being within the acceptable range of the respective order characteristic of the buyer order has a second value, and being unequal to the respective order characteristic of the buyer order has a third value. The system calculates an inventory score for each of the inventory products based on an aggregate of the value assigned to each of the plurality of inventory product characteristics. The system filters the inventory products based on the inventory score and a score threshold, thereby determining one or more matching inventory products. The system communicates to the buyer the matching inventory product(s) together with a respective merchant offer to purchase, where matching inventory products are arranged according to the inventory score.

In another embodiment, the system also provides an user interface to the buyer for inputting the plurality of order characteristics, applies a rule specification to the buyer order to constrain the order characteristics to one or more actual products, and receives a priority value for one or more of the plurality of order characteristics. In one embodiment, the value of one or more of the plurality of inventory product characteristics is weighted using the priority value.

In another embodiment of the method, the step of communicating to the buyer the matching inventory products includes communicating an indicator of negotiable price for one or more of the matching inventory products.

In another embodiment, the system communicates an electronic notification to the respective merchant of each matching inventory product having an indicator of negotiable price, where the electronic notification requests a revised price from each respective merchant. The system receives the revised price from one or more respective merchants and communicates to the buyer the revised price(s). In one embodiment, the electronic notification includes a time limit for each respective merchant to submit the revised price.

In another embodiment of the method, the step of filtering the matching inventory products includes reducing the first matching inventory products to N matches, where the value of N is selected or input by the buyer. In one embodiment, reducing the matching inventory products to N matches includes filtering the matching inventory products by a merchant rating of the respective merchants of the matching inventory products.

In another embodiment of the method, the step of communicating to the buyer the one or more first matching inventory products together with a respective merchant offer to purchase occurs asynchronously. In another embodiment, the system communicates to the buyer updated matching inventory products after the system receives a merchant communication containing a change in the inventory product characteristics for one or more of the matching inventory products.

In another embodiment of the method, the system also receives a buyer input to determine an alternate list of matching inventory products, selects matching inventory products having the top N2 inventory scores with the value of N2 being selected by the buyer, calculates at least one alternate inventory score for each of the N2 matching inventory products based on changing the respective priority values of the product characteristics; and communicates to the buyer the alternate matching inventory products based on the alternate inventory scores of the N2 matching inventory products.

In another embodiment of the method, the system determines that a plurality of first matching inventory products equally satisfy the order. The system solicits merchants of the plurality of first matching inventory products to submit a revised merchant offer to purchase including a revised product price.

In another embodiment of the method, the system also includes receiving a buyer acceptance of one or more merchant offer to purchase. The system receives input from the buyer to perform at one or more selected future date the repeated steps of determining whether each of the plurality of inventory product characteristics is equal to, within an acceptable range of, or unequal to the respective one of the plurality of order characteristics of the buyer order, thereby identifying one or more inventory products of at least one merchant having the plurality of order characteristics; assigning a score value to each of the plurality of inventory product characteristics, where being equal to the respective product characteristic of the buyer order has the first value, being within the acceptable range of the respective product characteristic of the buyer order has the second value, and being unequal to the respective product characteristic of the buyer order has the third value; calculating the inventory score for each of the inventory products based on the aggregate of the value assigned to each of the plurality of inventory product characteristics; filtering the inventory products based on the inventory score and the score threshold to determine one or more matching inventory products; and communicating to the buyer the one or more first matching inventory products together with the respective merchant offer to purchase, where the first matching inventory products are arranged according to the inventory score.

In one embodiment, the repeated steps are performed using a closed set of merchants selected from merchants of the first matching inventory products. In one embodiment, the matches are displayed to the user on a network-enabled device, such as a computer, tablet computer, cell phone, or other portable electronic device.

### BRIEF DESCRIPTION OF THE DRAWINGS

FIG. 1 is a flow diagram showing the interaction between rules and specifications of a method the present invention.

FIG. 2 is a representative diagram of one embodiment of a system of the present invention.

FIG. 3 is a flow diagram showing steps performed in one embodiment of a method of the present invention.

FIG. 4 is a code excerpt for a portion of one embodiment of the present invention.

FIG. 5 is a flow diagram showing steps performed in step 340 of the method illustrated in FIG. 3.

FIG. 6 is a flow diagram showing data flow between components of a system of the present invention.

### DETAILED DESCRIPTION OF THE PREFERRED EMBODIMENT

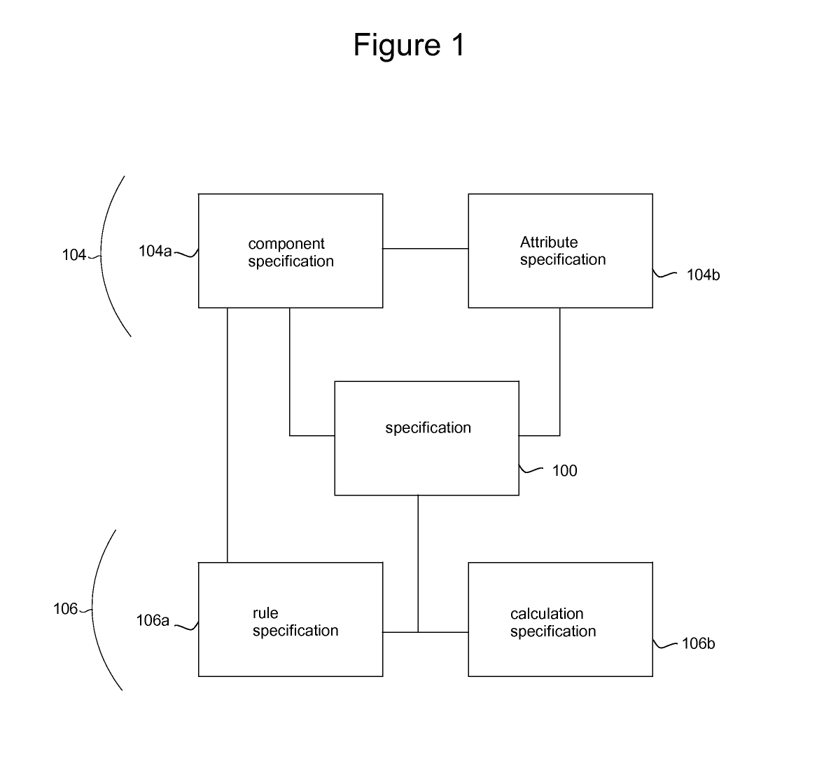

The preferred embodiments of the present invention are illustrated in FIGS. 1-6. The present invention includes concepts and design of a new e-commerce platform designed with extensibility as a key tenet. A wide range of products and services could be implemented on the platform, from simple products like office supplies, to consumer credit or highly complex products like automobiles.

The e-commerce system and method of the present invention supports an arbitrary product or service. For illustrative purposes, an automobile will be used in this description as the product sought to be purchased. The automobile is a familiar product to consumers and is a product purchase that involves complex or competing decisions. For these reasons, the automobile is an example of a product that provides common ground for understanding the system and method of the present invention.

A buyer is a motivated consumer of a product or service. A buyer can be an individual or business. A merchant or seller is an individual or business that offers products and/or services to the marketplace.

Given that either party can be an individual or business, this e-commerce platform supports peer-to-peer (p2p) commerce (i.e., commerce between individuals or between businesses) as well as individual-to-business transactions.

FIG. 1 illustrates a flow chart showing a specification 100 for a product 102, where specification 100 comprises a plurality of specification building blocks that include structural building blocks 104 and behavioral building blocks 106. At the heart of the e-commerce platform, the definition of a product includes goods and services and also must be flexible and extensible: specification 100 embodies the universe of all options that could be selected for a given product or service to be purchased. To achieve this end, specification 100 has structural building blocks 104 and behavioral building blocks 106. Structural building blocks 104 include a component specification 104a and an attribute specification 104b. Component specification 104a identifies the presence or absence of a feature. Attribute specification 104b identifies the value, variety, or quality of a feature present in the product. Behavioral building blocks 106 include a rule specification 106a and a calculation specification 106b.

When product 102 (not shown) is an automobile, for example, product 102 has attributes like paint color, body type (e.g., sedan or coupe), and interior finishes (e.g., leather or cloth upholstery and wood or vinyl trim). In one embodiment, components are major sub-systems of product 102 (e.g. engine characteristics) or packaged features (e.g. sport package, cold weather package). By having very simple building blocks, like attribute and component, system can describe any type of product 102.

In one product, for example, one component is two-tone paint and a corresponding attribute is the specific color combination (e.g., silver and black); a second component is a diesel engine and corresponding attributes include the engine size, fuel economy rating, and turbo option; a third component is seating and corresponding attributes include bucket or bench seats, cloth or leather finish, power seat options, size/space/dimensions, and other attributes.

Rule specifications 106a are meant to enforce the validity of specification 100 in the context of an “actual” (i.e., the inventory available for purchase). For example, it might not be possible to order a red car unless the buyer chooses the sports package. Similarly, it may not be possible to combine certain features (e.g., exterior color/interior color) based on how the manufacturing process is defined. Rule specifications 106a allow specification 100 to express what choices are permitted and valid so that the consumer is not allowed to order a product 102 that doesn't exist. Rule specifications 106a can be attached to specification components 104a, 104b or to specification 100.

Calculation specification 106b is configured to use information provided by the user in the context of specification 100 to compute a result. A simple example of calculation specification 106b is determining the price of a car based on all the options and packages selected, where the total price includes the base price in addition to prices for each added package or option.

As shown in FIG. 1, specification 100 and calculation specification 106b are governed by rule specification 106a. That is, structural building blocks 104 define a product and behavioral building 106 blocks constrain combinations of structural building blocks 104 to products that actually exist in the marketplace. Therefore, calculations are performed only for actual products. For example, when a buyer of an automobile selects the option for “sedan” as a component, rule specification 106a then populates, activates, or otherwise allows subsequent selection of components and attributes such as paint color (e.g., black, red, or silver), number of doors (e.g., two or four door), and interior finishes (e.g., black leather, tan leather, or grey cloth) that are available on sedan models. Rule specification 106a, however, does not allow the user to select components or attributes that are not available for a sedan (e.g., fifth wheel trailer hitch). Accordingly, rule specification 106a depopulates, deactivates, removes from selection menus, or otherwise does not allow subsequent selections of invalid product choices.

Rule specification may be implemented in a variety of ways on an e-commerce platform. In one embodiment, a user interface displayed on the buyer computer 260 has drop-down menus, radio buttons, lists, or other methods to convey the available components and attributes to the user. These menus, buttons, lists or the like are presented to the user in a sequence defined by the rule specification 106a so that only valid choices are presented to the user. In one embodiment, the full range of choices are presented to the buyer at the same time using menus, buttons, lists, etc, but where making a selection affects the options available to the user for subsequent choices. For example, using an automobile as product 102, the user may first select the make from various menus that allow one of many choices. The initial selection of “make” is followed by the body type, the components, and then by the attributes. A given make determines what body types are available. Subsequent choices of components and attributes are determined or narrowed by initially selecting the make of automobile. It is also acceptable for the buyer to first select an attribute or component of product 102, where other subsequent criteria may be selected based on the first selection. For example, selecting black leather interior could determine which makes and/or models of automobile are available with black leather interior.

In another example, all of the components and attributes for a given product or class of products are visible and selectable by the user at the same time. Making any choice causes rule specification 106a to populate/depopulate, activate/deactivate other choices. If the user first selects red leather interior, rule specification 106a determines which makes, body types, components, and attributes are permitted with a red leather interior. The permitted choices are then made available to the buyer for further selection.

An “actual” is a valid instance of a specification. Rule specification 106a defines the components and attributes of products or “actuals” available to the buyer or offered by the merchant. As used in systems and methods of the present invention, a buyer actual is the specific product or service that the buyer wants to buy and that has permitted attributes and components as defined by specification 100. The buyer actual is also referred to as “the order” placed by the buyer. Similarly, a merchant actual is the particular inventory product that the merchant has available for sale. For the purposes of this specification, a merchant actual is a product or service that the merchant can produce for sale within a reasonable time frame to fulfill a contract. In one embodiment, whether a product is in stock or “on the shelf” will not affect the product from being included within merchant actual inventory, but the product's availability may affect the delivery terms of the offer. This allows the system to include merchants who do not actually stock a given product, but who are available to obtain the product.

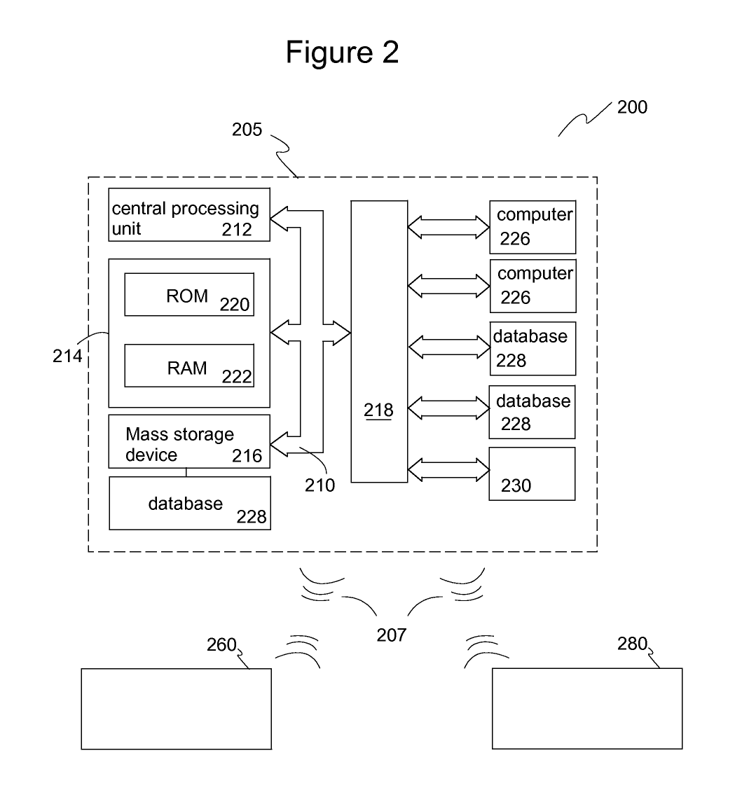

Referring now to FIG. 2, components are illustrated of one embodiment of a system 200 configured to perform methods of electronic commerce 300 as discussed herein. System 200 includes a computer network 205 disposed in communication with at least one buyer computer 260 and disposed in communication with at least one seller or merchant computer 280. Each buyer computer 260 and each merchant computer 280 communicate and exchange data with computer network 205 using a wired or wireless connection 207.

Embodiments of the present invention embrace one or more computer readable medium, where each medium includes or may be configured to include data or computer-executable instructions for manipulating data. The computer-executable instructions include data structures, objects, programs, routines, or other program modules that may be accessed by a processing system, such as one associated with a general-purpose computer capable of performing various different functions or one associated with a special-purpose computer capable of performing a limited number of functions.

Computer-executable instructions cause computing network 205 to perform a particular function or group of functions and are examples of program code for implementing steps of methods of the present invention. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disc read-only memory (CD-ROM”), or any other device component that is capable of processing data or executable instructions that may be accessed by a processing system.

Connection 207 can be wired or wireless and made using a local area network, wide area network, or the Internet. Computer network 205 includes, for example, a stand-alone general purpose or special-purpose computer, a network computer, and/or a plurality of hardware and software components connected to a network and configured to operate in communication with one another.

In one embodiment, computer network 205 includes a system bus 210 of any architecture and configured to connect various components in communication and enable data to be exchanged between the components. Typical components connected to system bus 210 include a processing system or central processing unit 212, memory 214, and mass storage devices 216, and one or more network interfaces 218, each of which will be discussed below. Central processing unit 212 includes one or more processors, such as a central processor, and optionally one or more other processors designed to perform a particular function or task. Central processing unit 212 typically executes instructions provided on computer readable media, such as in memory 214 or in a mass storage device 216.

Memory 214 includes one or more computer readable media that includes or may be configured to include data or instructions for manipulating data, and may be accessed by central processing unit 212 through system bus 210. Memory 214 may include, for example, ROM 220, used to permanently store information, and/or RAM 222, used to temporarily store information. ROM 220 may include basic input/output system (“BIOS”) having one or more routines that are used to establish communication, such as during start-up of computer network 205. RAM 222 may include one or more program modules, such as one or more operating systems, application programs, and/or program data.

In one embodiment, one or more mass storage devices 216 comprise a single unit with central processing unit 212 and memory 214. One or more mass storage devices 216 optionally are disposed in communication with central processing unit 212 and memory via system bus 210 and/or network interface 218. Examples of mass storage devices 216 include hard disk drives, magnetic disk drives, tape drives, optical disk drives, and other computer-readable media known in the art. Mass storage device(s) 216 and corresponding computer readable media provide nonvolatile storage of data and/or executable instructions that may include one or more program modules such as an operating system, one or more application programs, other program modules, or program data, such executable instruction are examples of program code meant for implementing steps of methods disclosed herein.

One or more network interfaces 218 may be employed to enable a user to input data and/or instructions to computer network 205 through one or more corresponding input devices on buyer computer 260 and on merchant computer 280. Examples of such input devices include a keyboard and alternative input devices, such as a pointing device (e.g., mouse, light pen, stylus), touch screen, microphone, a joystick, a game pad, a scanner, a digital camera, and the like. Similarly, examples of input interfaces that may be used to connect the input devices to system bus 210 include, serial port, a parallel port, a universal serial bus (“USB”), a fire wire (IEEE 1394), a wireless communication interface, or other interface.

One or more network interfaces 218 enable computer network 205 to exchange information with one or more additional local or remote computers 226, databases 228, or other component 230. Examples of network interfaces include a network adapter for connection to a local area network (“LAN”) or a modem, wireless link, or other adapter for connection to a wide area network (“WAN”), such as the Internet. Network interface 218 may be incorporated with or secondary to central processing unit 212, memory 214, and/or mass storage device 216. In a networked system, accessible program modules or portions thereof may be stored in a remote storage device. Furthermore, computer network 205 may participate in a distributed computing environment, where functions or tasks are performed by a plurality of networked computer devices 226.

Examples of buyer computer 260 and of merchant computer 280 include a desktop or laptop computer, a wireless “smart” phone, a tablet computer, a personal digital assistant (PDA), and a network workstation. Each of buyer computer 260 and merchant computer 280 preferably have one or more output devices 230 (not shown), such as a display screen, printer, speaker, vibration alert, and the like. Output device 230 is used to display or otherwise communicate results to the user.

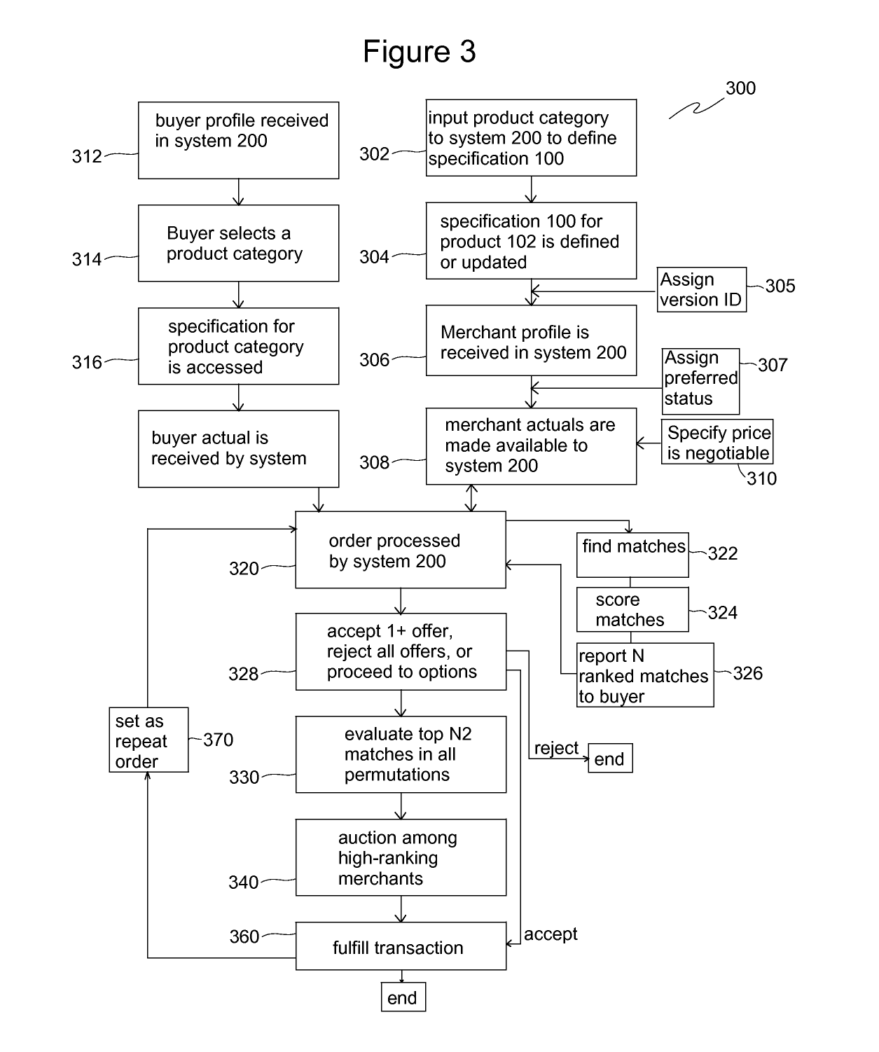

Referring now to FIG. 3, a flow chart illustrates process blocks and decision blocks of one embodiment of method 300. Unless specifically indicated, steps of method 300 can be performed in sequences other than shown in FIG. 3.

In step 302, a category of products or services is input to or made available to e-commerce system 200 to define the necessary product or service specifications 100. Step 302 is typically performed, for example, by an employee of the e-commerce company or a subject matter expert who can guide the creation of a universal specification for a particular product type or service. Specification(s) 100 also may be obtained from manufacturers, retailers, or consultants and accessed by system 200 from a local or offsite database.

In step 304, a graphical configuration tool is used to define a product or service specification 100. A product or service will be composed of reusable component specifications 104a, attribute specifications 104b, rule specifications 106a, and calculations 106b. Once defined, specification 100 is represented in a file format, such as XML, and stored in the product/service repository or database 228. Database 228 may be a relational database or an indexed file system store. In step 305, a version identifier is assigned to each product specification 100 so that as product components or attributes change over time, specification 100 can be updated to reflect these changes. The version identifier also allows one to determine the date of creation for a specification 100 or the date specification was last deemed accurate and/or complete.

In step 306 a merchant registers with the e-commerce platform through a web site and provides the necessary data for a consumer profile 419 so that system 200 can contact the merchant by its preferred method (e.g., by e-mail, SMS texts, or directly to a native application on a mobile device). The merchant also provides data for a merchant profile 421, such as contact and settlement information, so that it can be paid for the products or services purchased by the buyer. Commission rates and tiered status optionally are made available to the merchant to receive preferential treatment as part of the shopping process. Preferential treatment or preferred status means an increase in the inventory score (discussed below) based, for example, on the merchant's transaction history, positive customer reviews, certification as a reputable merchant, product pricing compared to or discounts from the manufacturer's suggested retail price, the merchant's payment for preferred status, or other criterion or criteria.

In step 308, merchant actuals, the merchant's inventory products that are in stock and available for sale, are made available to computer network 205. The format and validity of the data of the merchant actuals is governed by specification 100. In one embodiment, an electronic data format is generated from specification 100, where an empty record for a merchant actual is provided for the purpose of collecting data from the merchant.

This data format allows the merchant to provide inventory products to system 200 through various interaction methods. In one method, system 200 accepts inventory product information through a callable web service interface that the merchant uses to “push” the data. In a second method, system 200 invokes a merchant web service to “pull” the data, adapting as necessary to the differences between the platform's internal representation and the merchant's information system. In a third method, the merchant generates a batch file in a required format and uploads the batch file to system 200.

In one embodiment, system 200 receives and/or updates merchant actuals on a per-merchant basis and can take place at a frequency specified by the merchant, such as weekly, daily, hourly, or whenever a change occurs in merchant actuals. Preferably, merchant actuals in system 200 are updated at least once daily by system 200 initiating data exchanges with merchant computer 280. In one embodiment, system 200 receives inventory products from merchants by communicating with a merchant's in-house computer system, which tracks the number and availability of inventory products as they are sold and replenished by the merchant. Optionally, software stored on merchant computer 280 may be configured to initiate data exchanges with system 200 on a predefined schedule.

In step 310, the merchant optionally indicates that its price is negotiable. In providing inventory products to system 200, this option allows the merchant to consider special circumstances (e.g. bulk orders, standing orders, ease of filling an order) or to compete against other merchants as part of the sales process. Merchant actuals have either a clearly defined price or have the information needed to calculate a price for product 102. Specification 100 holds the necessary information to compute price via calculations, rules, and attributes. The merchant actual has either a defined price attribute or an attribute indicating price negotiations. In one embodiment, the merchant optionally indicates that price is negotiable and that the merchant agrees to participate in negotiation or an auction when a plurality of merchant actuals each match or satisfy specification 100 of product 102. Preferably, negotiation or an auction occurs only when a plurality of inventory products satisfy the buyer order by being equal matches or within an acceptable range for a plurality of product characteristics specified in the buyer order.

In step 312, a buyer registers with the e-commerce platform through the website. The buyer provides the necessary profile data so that system 200 can contact the buyer by the buyer's preferred method (e.g., e-mail, SMS texts, or directly to a native application on the buyer's mobile device). The buyer also provides payment information (any/all forms of online payment are preferably accepted—bank debit or credit cards, wire transfer, PayPal, V.me, and even Internet currency such as bitcoins). By successfully registering with system 200, the buyer is accepted by system 200 as having the ability to accept to purchase and pay for inventory products offered by merchants. When system 200 receives profiles for buyers and merchants in addition to having received or having access to merchant actuals, the buyer can begin shopping.

In step 314, the buyer selects a product or service category by accessing system 200 with buyer's computer 260 located at a different location from system 200. For example, buyer uses a tablet computer or smart phone to access system 200 via the Internet. In this example, product 102 is an automobile.

In step 316, system 200 locates, identifies, calls, or receives a product specification 100 for the product or service sought to be purchased. Specification 100 may be created for system 200, may be provided by a manufacturer for use by system 200, or made available from another source. The specification engine applies rule specification 106a to dynamically generate a user interface for collecting information from the buyer to create a buyer order for product 102 and specify product characteristics, such as components, attributes, product price, and a delivery term. In the case of a category for automobiles, for example, the user interface would have attributes and components of automobiles. Depending on the type of product 102 and the number of options available, an appropriate user interface (e.g., having lists, check boxes, radio buttons, text fields, etc.) is used to capture the user's selection for as many product attributes and components as the user chooses to enter. Rules of specification 100 control choices available to the buyer. Inter-dependent items will make use of rich user interface features to show or hide selection choices or to change the content of a dropdown list as needed so that only valid choices are offered to the buyer.

In step 318, the buyer's order (i.e., product 102 as desired) is received by system 200. Using the user interface, the buyer chooses exact details for attributes and components of product 102 in addition to price and delivery term as desired. In some embodiments, an attribute or component is selected on a pass/fail basis. Optionally, the buyer indicates that an attribute or component selection is “firm,” therefore a merchant actual is or is not acceptable as a “match” if it does not have the selected attribute it is supposed to have or if it has the selected attribute it is not supposed to have. Optionally, by setting an acceptable range for an attribute, or by indicating that a selected attribute is “soft,” the buyer can broaden the range of “matches” to include products that may or may not have all attributes or components considered to be less important to the buyer.

For example, a buyer who wants to buy only a red sedan may indicate that “sedan” is a firm attribute. Therefore, if the automobile is not a sedan, it will not be returned as a match. The buyer may also select the color red as a “firm” attribute, so that only red sedans will be returned as a match. Further, the buyer may select acceptable red colors individually or as a range among the available choices, such as cherry red, fire engine red, red sparkle, and wine red. Selecting more than one attribute or component choice defines an acceptable range for that attribute or component. Similarly, setting upper and lower range limits (e.g., seating capacity minimum and maximum, price range, fuel economy limits) defines one or more acceptable range. By further selecting price limitations, interior finishes, and trim packages, the matchmaker module will only return results to the buyer with the red sedan he wishes to buy rather than the buyer being overwhelmed with irrelevant search results. Similarly, the buyer may choose “not” as an option for a product characteristic. For example, the buyer may specify color as “not red” and delivery term as being shipped from a location not more than 500 miles away.

The user can be as precise or as lenient as desired in order to receive matches that accurately reflect product characteristics sought by the buyer. Similarly, the user can specify other parameters that may be important to the purchase of the product or service, like delivery deadlines, shipping costs, quantity, quality, and price. After attributes are specified by the buyer, the buyer can rank the attributes in order of priority. For example, the user drags and drops attributes in a list to indicate the preference between items in the list. Alternately, the buyer can assign a preference value to a characteristic that indicates the relative importance of that characteristic. After attributes are selected and the preference between attributes and components is input by the user, the user submits the data to system 200 as the buyer actual or “the buyer order.”

In step 320, the order is processed by system 200. In one embodiment, step 320 includes steps 322 (finding matches), 324 (calculating score values and inventory score), and 326 (reporting matching inventory products to the buyer), which are discussed in more detail below. Unlike a typical Internet search that performs one search and returns a list of search results based on keywords, the processing of the buyer order in method 300 takes place asynchronously. That is, identifying matching inventory products may occur over time rather than as a single step. The buyer is not required to sit and wait for results to be returned. Also, the buyer is not required to analyze and compare the results against each other to determine which one is the best choice. Optionally, the buyer specifies the length of time or deadline within which searching and results must be returned. In one embodiment, since matching results are returned and/or updated asynchronously, the list of matching inventory products communicated to the buyer is updated over time to reflect the changing availability of merchant inventory. In another embodiment, the list of matching inventory products communicated to the buyer is allowed only to increase over a predefined length of time as additional inventory products from other merchants become available, where matching results are held or guaranteed until expiration of the predefined length of time.

In step 322, matches are identified by comparing the buyer order with inventory products of merchants. For each of a plurality of product characteristics (e.g., attribute, component, price, delivery term), system 200 determines whether the actual product(s) defined by the buyer order and the inventory products of merchants are an exact match, within an acceptable range, or a non-match. In one embodiment, a result is marked as no match or a miss when the actual product(s) defined by the buyer order is not available. In one embodiment, system 200 continues to search inventory products for matches with the buyer order, where system 200 compares each product characteristic and associated priority value and/or flexibility/firmness of the characteristics indicated in the buyer order with inventory products of merchants. Continued searching may occur periodically, sporadically, at specified times or intervals, or continuously. Therefore, as inventory products of merchants change over time, matches are communicated to the user as they are discovered by system 200. In this way, the buyer may specify a hard-to-find product or difficult-to-meet set of product characteristics and then wait for matching inventory products to be communicated to the buyer with an opportunity to purchase the item.

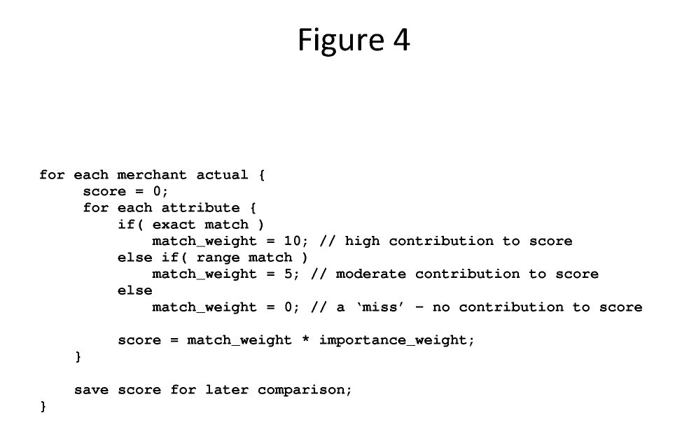

In step 324, a score value is calculated for each product characteristic. In one embodiment, the score value for one or more product characteristic is weighted using the preference value. The aggregate of score values for the product characteristics are used to calculate an inventory score for inventory products matching the buyer order. In one embodiment, the inventory score is calculated according to the pseudo-code shown in FIG. 4. In one embodiment, the value of the variable importance weight in the code is a decreasing coefficient, where the highest ranked attribute has the highest value of importance weight. In one embodiment, a preferred status value is added to the total inventory score for a merchant who, for example, has a reduced commission rate, has high customer feedback, or for some other factor or combination of factors.

In step 326, matching inventory products are filtered and communicated to the buyer. If at least one matching inventory product is found, then the buyer is presented with the match(es), preferably during the same session established on the Internet or mobile device. Matching is intended to take place in real time. Matches may be found over time (e.g., minutes, hours) or at about the same time (e.g., within seconds). In any case, the buyer is notified (again asynchronously) through the preferred contact mechanism (e.g., e-mail, SMS, or mobile application) as matching inventory products are identified for the order. Matching inventory products are preferably presented to the buyer according to inventory score value, such as in a list of descending inventory score. In one embodiment, results of matching inventory products are displayed to the user on the user's computer/electronic device with a listing of selected characteristics, match values for the selected characteristics, and the total inventory score value. When the buyer specifies a deadline, system 200 optionally alerts the buyer when the deadline expires so that the buyer may then evaluate the returned offers from merchants. However, the buyer need not wait until all matches or offers are returned, but may accept an offer before the deadline.

At this point, the buyer will have 0 to N ranked matches for the buyer order, each matching inventory product being presented along with an offer to the buyer to purchase the inventory product. Preferably, the buyer selects the value of N so as to control the number of offers from merchants the buyer wishes to consider. In step 328, The buyer can choose to accept one or more offer and then proceed to fulfillment or the buyer can reject all offers if the criteria are deemed not close enough for a deal.

Optionally, each merchant can specify an expiration time and date for the offer to purchase the matching inventory product. In another embodiment, if an offer has not yet been accepted by the buyer, a merchant's offer is automatically retracted and/or replaced with a new offer in the event that the merchant's price increases or availability changes for product 102.

In step 330, the buyer optionally requests that the top N2 matches be evaluated in all permutations to determine one or more alternate results, where N2 is a value that can be specified by the buyer and typically has a value of three. For example, if an user prioritizes attributes A, B, and C in order 1, 2, 3, respectively, system 200 evaluates all priority permutations of attributes A, B, and C and the respective priorities to determine alternate results, if any. That is, results having attribute priorities of A-B-C, A-C-B, B-C-A, B-A-C, C-B-A, and C-A-B are evaluated. The alternate results will be displayed along with the buyer's original preferences showcasing the differences between the original matches and the alternate matches. This feature allows buyer to make the most informed decision without any additional research on the buyer's part.

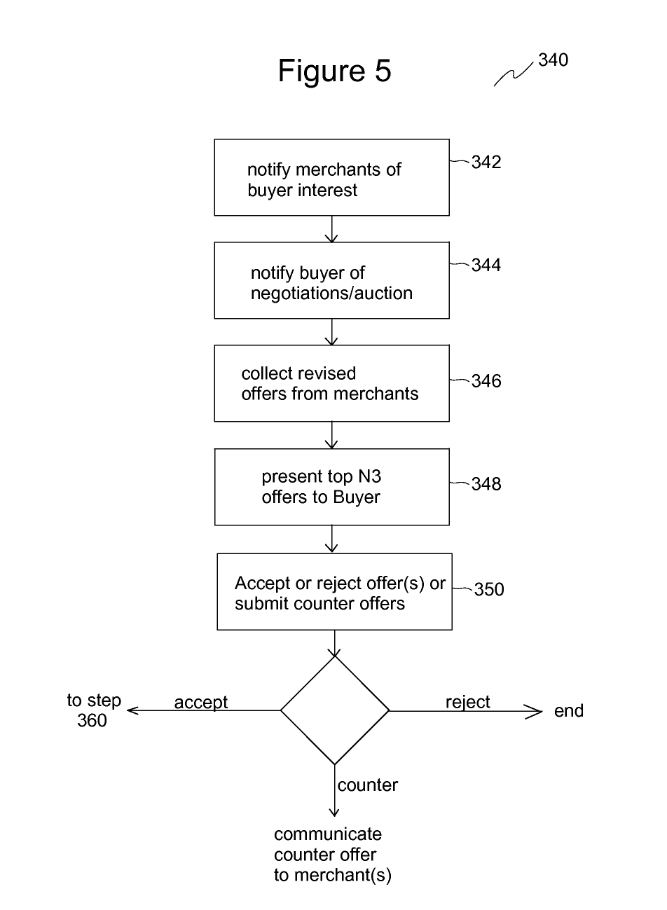

In step 340, an optional auction is conducted among merchants of the N3 highest ranking matches. If one or more matches with a high-ranking score are from a merchant who indicated that price is negotiable, then an electronic auction is conducted among these merchants and the buyer. Detail of one embodiment of step 340 is illustrated in FIG. 5, which shows step 340 comprising steps 342-350.

In step 342, the merchant(s) are notified via their preferred contact method (e.g., e-mail, SMS, mobile application) that a buyer is interested in a specific inventory item. The buyer's desired purchase price is included. In addition, the merchants are notified if other merchants are invited to participate in the negotiation process or auction. If desired, a merchant invited to participate may submit a revised offer within a fixed time period.

In step 344, the buyer is notified that price negotiations are in progress. Notification occurs by the preferred method indicated by the buyer.

In step 346, system 200 iteratively collects revised offers from merchants and informs the participating merchants and the buyer of the current offer status. Until the fixed time period expires or until an offer is accepted by the buyer, the merchant(s) can continue to respond with revised offers based on the current bids submitted by other merchants. In one embodiment, system 200 collects revised offers from merchants on a sealed-bid basis or “Vickery” auction, where merchants do not know the offers being made by other merchants. In another embodiment, each merchant participating in the negotiation process submits one final and best offer before the fixed time period expires. If a final, best offer is not submitted, the merchant's previous offer is allowed to stand unchanged. In this embodiment, the final, best offers may be visible or invisible to other merchants participating in the negotiation process.

In step 348, after the fixed time period has expired or after all participating merchants have indicated that no further revised offers will be submitted (whichever comes first), the buyer is presented with up to the top N3 offers where N3 has a value that can be set by the buyer. The buyer makes the ultimate decision on the purchase through the user interface displayed on buyer's computer 260.

In step 350, having been presented with the top N3 offers, the buyer can proceed to (a) accept one or more offer and proceed to fulfillment, (b) reject all offers if the criteria are not close enough for a deal, or (c) submit a counter offer to the merchant(s) to negotiate different terms than presented.

It would be expected that commodity products/services would not require this complex set of interactions since calculations could determine a fair price automatically. Since method 300 is preferably universal to support the buying process for more expensive products, like cars, method 300 preferably includes the negotiation process of steps 342-350.

In step 360, after the buyer accepts at least one offer, system 200 accesses the buyer's preferred payment method stored in the buyer's profile. System 200 also accesses the buyer's shipping address and other details stored in the buyer's profile as needed to complete the transaction and delivery of product 102.

In one embodiment, step 360 includes, the winning merchant being paid for the order in full based on the merchant's stored profile information, less any pre-arranged commission.

In step 370, the buyer optionally selects to repeat placing the order as a standing order. For example, the buyer wishes to purchase 10 reams of white paper once per month. In one embodiment, after the consumer selects a merchant and completes the transaction, the consumer has the option to repeat the purchase of the same product on a periodic basis with the same merchant. The user also has the option to repeat the process of searching for the best match among available merchants. When the merchant is not the same merchant on a repeating order, the same order with the same specification is automatically processed beginning with step 320 at the frequency indicated by the buyer. The best match at the pre-selected interval may yield different results depending on merchant sales conditions at the time. Using this feature, the buyer is always guaranteed to get the best match at the time of his subsequent order. Optionally, the merchant whose offer was accepted for the transaction that resulted in a repeat or standing order has a preferred status value added that merchant's total inventory score in the standing or repeat order. The amount of the preferred status value can be adjusted to result in the desired effect in the rank of that merchant in the repeat or standing orders.

In one embodiment, method 300 is repeated from step 320 on a periodic basis, where the best match may or may not include the same merchant as the previous purchase. That is, method 300 is performed again from step 320 based on merchant actuals available at the time.

In another embodiment, method 300 is repeated from step 320 based on the top N4 matches, where N4 is a value that the buyer can set and preferably has a value from three to five. In this embodiment, method 300 is performed based on merchant actuals from a closed set of N4 merchants.

In step 380, for standing orders, the buyer optionally receives special discount offers for product 102 specified in the standing order. If a merchant's discount meets certain pre-selected criteria, the buyer will be notified about the special and can opt to purchase the product at the discounted price prior to the scheduled date of an existing recurring order.

In step 390, a data warehouse takes periodic data feeds from system 200 to collect information about merchants, buyers, and their behavioral patterns. Preferably, data feeds are taken using an Extract-Transform-Load (ETL) process as is known in the art.

In step 392, reports 424 are generated by system 200. Reports 424 preferably include analytical analysis for one or more of the activities that include cross-sell or up-sell promotions to consumers; targeted marketing to consumers based on past spending patterns; offers for recurring, scheduled purchases with specific merchants; offers for consumer information feed (if opt-in) to merchants to perform their own targeted marketing; and other heuristics as discovered in the future.

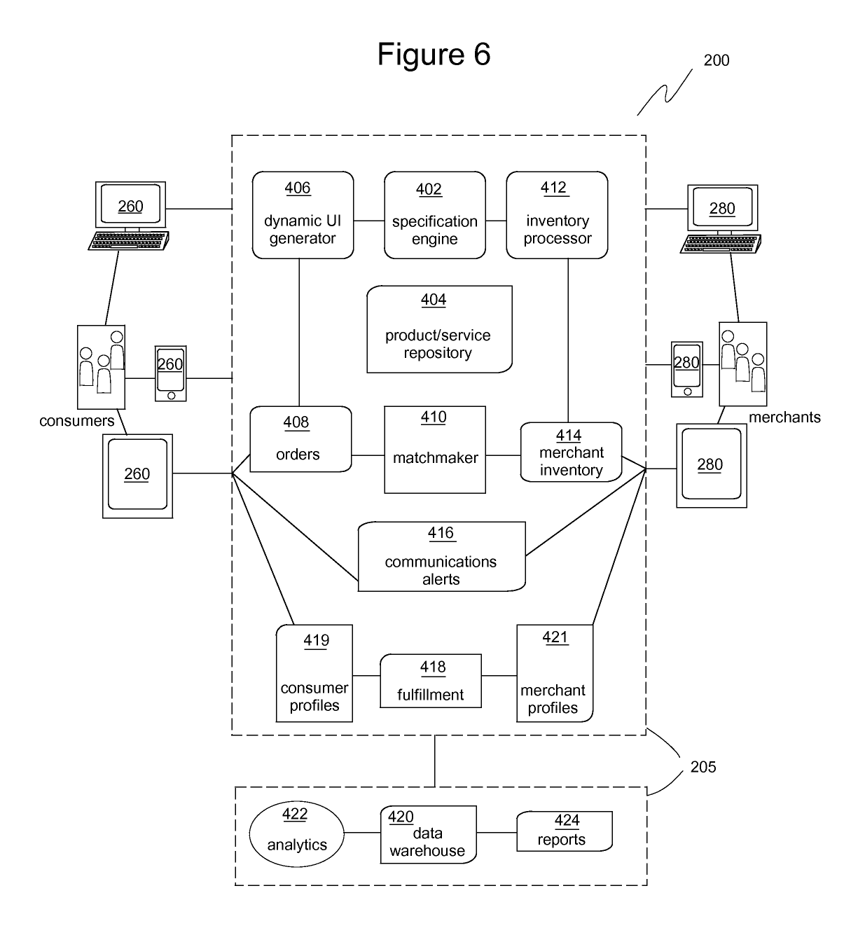

Referring now to FIG. 6, a diagram illustrates data flow between components and modules of one embodiment of system 200. Buyer computer 260 and merchant computer 280 each exchanges data with computer network 205. Computer network 205 includes computing modules that perform steps of method 300 as discussed above. A specification engine 402 accesses data stored in a product/service repository 404. Specification engine 402 communicates data to a dynamic user interface generator 406. Specification engine 402 also exchanges data with an inventory processor 412, which receives data from a merchant inventory database 414, the module to which merchants input merchant actuals.

Dynamic user interface generator 406 creates or displays a user interface with appropriate selection choices needed to capture the buyer's order for product 102. Buyer enters the order to system 200 using the user interface. An order module 408 receives the order from the buyer and uses the user interface communicated to it by dynamic user interface generator. Order module 408 communicates the order to a matchmaker module 410. Matchmaker module 410 compares orders from order module 408 with merchant actuals stored in a merchant inventory database 414 or memory 214.

Upon determining whether the order matches merchant actuals, matchmaker module 410 communicates the result to a communications alerts module 416. The communication alerts module 416 sends information, prompts users for input, and communicates other messages to buyer computer 260 and merchant computer 280. Upon receiving notice that buyer has accepted an offer, fulfillment module 418 processes payment by accessing the buyer profile and the merchant profile. Fulfillment module 418 communicates data to a data warehouse or database 420. Data warehouse 420 calls algorithms in an analytics module 422 and outputs reports 424.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

The claimed invention is:

1. A method of electronic commerce comprising:
a system at a first location receiving a buyer order defining one or more actual products communicated to the system from a buyer computer located at a different location, wherein the buyer order specifies a plurality of order characteristics selected from the group consisting of one or more product components, one or more product attributes, a product price, and one or more delivery term;
the system determining whether each of a plurality of inventory product characteristics is equal to, within an acceptable range of, or unequal to the respective one of the plurality of order characteristics of the buyer order, thereby identifying one or more inventory products of at least one merchant having the plurality of order characteristics;
the system assigning a value to each of the plurality of inventory product characteristics, wherein being equal to the respective order characteristic of the buyer order has a first value, being within the acceptable range of the respective order characteristic of the buyer order has a second value, and being unequal to the respective order characteristic of the buyer order has a third value;
the system calculating an inventory score for each of the inventory products based on an aggregate of the value assigned to each of the plurality of inventory product characteristics;
filtering the inventory products based on the inventory score and a score threshold, thereby determining one or more matching inventory products; and
the system communicating to the buyer the one or more first matching inventory products together with a respective merchant offer to purchase, wherein the one or more first matching inventory products are arranged according to the inventory score.

2. The method of claim 2, further comprising:
the system providing an user interface to the buyer for inputting the plurality of order characteristics;
the system applying a rule specification to the buyer order, thereby constraining the plurality of order characteristics to one or more actual products; and
the system receiving a priority value for one or more of the plurality of order characteristics.

3. The method of claim 2, wherein the value of one or more of the plurality of inventory product characteristics is weighted using the priority value.

4. The method according to claim 1, wherein the step of communicating to the buyer the first matching inventory products includes communicating an indicator of negotiable price for one or more of the first matching inventory products.

5. The method according to claim 4, further comprising:
the system communicating an electronic notification to the respective merchant of each of the plurality of first matching inventory products having an indicator of negotiable price, wherein the electronic notification requests a revised price from each respective merchant;
the system receiving the revised price from one or more respective merchants; and
communicating to the buyer the one or more revised price of the first matching inventory products.

6. The method according to claim 5, wherein the electronic notification includes a time limit for each respective merchant to submit the revised price.

7. The method of electronic commerce according to claim 1, wherein the step of filtering the matching inventory products includes reducing the first matching inventory products to N matches, a value of N being selected by the buyer.

8. The method according to claim 7, wherein reducing the matching inventory products to N matches includes filtering the matching inventory products by a merchant rating of the respective merchants of the first matching inventory products.

9. The method according to claim 1, wherein the step of communicating to the buyer the one or more first matching inventory products together with a respective merchant offer to purchase occurs asynchronously.

10. The method of claim 9, further comprising:
communicating to the buyer updated matching inventory products after the system receives a merchant communication containing a change in the inventory product characteristics for one or more of the first matching inventory products.

11. The method of claim 1, further comprising:
the system receiving a buyer input to determine an alternate list of matching inventory products;
the system selecting matching inventory products having the top N2 inventory scores, the value of N2 selected by the buyer;
the system calculating at least one alternate inventory score for each of the N2 matching inventory products based on changing the respective priority values of the plurality of product characteristics; and
the system communicating to the buyer the alternate matching inventory products based on the at least one alternate inventory score for each N2 matching inventory products.

12. The method of claim 1, further comprising:
the system determining that a plurality of first matching inventory products equally satisfy the order characteristics; and
the system soliciting merchants of the plurality of first matching inventory products equally satisfying the order characteristics to submit a revised merchant offer to purchase including a revised product price;

13. The method of claim 1, further comprising:
the system receiving a buyer acceptance of one or more merchant offer to purchase;
the system receiving input from the buyer to perform at one or more selected future date the repeated steps of:
the system determining whether each of the plurality of inventory product characteristics is equal to, within an acceptable range of, or unequal to the respective one of the plurality of order characteristics of the buyer order, thereby identifying one or more inventory products of at least one merchant having the plurality of order characteristics;
the system assigning a score value to each of the plurality of inventory product characteristics, wherein being equal to the respective product characteristic of the buyer order has the first value, being within the acceptable range of the respective product characteristic of the buyer order has the second value, and being unequal to the respective product characteristic of the buyer order has the third value;
the system calculating the inventory score for each of the inventory products based on the aggregate of the value assigned to each of the plurality of inventory product characteristics;
filtering the inventory products based on the inventory score and the score threshold, thereby determining one or more matching inventory products; and
the system communicating to the buyer the one or more first matching inventory products together with the respective merchant offer to purchase, wherein the one or more first matching inventory products are arranged according to the inventory score.

14. The method according to claim 13, wherein the repeated steps are performed using a closed set of merchants selected from merchants of the first matching inventory products.
